(19) United States
(12) Patent Application Publication
(10) Pub. No.: US 2015/0242380 A1
(43) Pub. Date: Aug. 27, 2015

(54) CHECKING TESTING COVERAGE

(71) Applicant: International Business Machines Corporation, Armonk, NY (US)

(72) Inventors: Bing J. Guo, Shanghai (CN); Yang Liu, Shanghai (CN); Qi Ruan, Ningbo (CN); Pei Wang, Shanghai (CN); Deng P. Zhou, Shanghai (CN)

(21) Appl. No.: 14/623,827

(22) Filed: Feb. 17, 2015

(30) Foreign Application Priority Data
Feb. 27, 2014 (CN) 201410068217.6

(51) Int. Cl. G06F 17/22

(52) U.S. Cl. CPC G06F 17/2247; G06F 17/2241

(57) ABSTRACT

Checking testing coverage. In response to testing a function of a widget, changes of DOM nodes of the widget are recorded. Description of a DOM structure corresponding to the function is obtained. The recorded changes of DOM nodes and the obtained description of the DOM structure are compared. Testing coverage condition for the function according to a comparison result is then determined.

### BACKGROUND

The present invention relates to the field of automated testing, and more specifically, to a method and system for checking testing coverage.

Nowadays with the constant development of software technology, hardware technology and communication technology, network applications, cellphone applications, computer applications, server applications or other applications are increasingly popular. An application, before being released, needs to be tested. User interface (UI) testing, especially widget testing, is an important part of application testing.

Currently most of widget testing is manual testing. However, since testers are usually not developers, it is quite hard to successfully test all functions. Thus, it may be difficult to determine which functions of the widget have not been fully tested. Testing may be inefficient, and results are may not be reliable.

Even by using automated testing tools, there still lacks an effective way to evaluate testing coverage.

### SUMMARY

Embodiments of the present invention disclose a method, computer program product, and system for checking testing coverage. In response to testing a function of a widget, changes of DOM nodes of the widget are recorded. Description of a DOM structure corresponding to the function is obtained. The recorded changes of DOM nodes and the obtained description of the DOM structure are compared. Testing coverage condition for the function according to a comparison result is then determined.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent. The same reference numeral generally refers to the same components in the embodiments of the present disclosure.

FIG. 1 shows an exemplary computer system/server 12 which is applicable to implement the embodiments of the present invention.

FIG. 2 shows a schematic flowchart of a method for checking testing coverage according to one embodiment of the present invention.

FIG. 3 shows a schematic view of a DOM tree according to one embodiment of the present invention.

FIG. 4A shows an example of one function performed by a widget and description of a DOM structure corresponding to the function according to one embodiment of the present invention.

FIG. 4B shows an example of another function performed by the widget and description of a DOM structure corresponding to the function according to one embodiment of the present invention.

FIG. 5 shows an example of a report provided by one embodiment of the present invention.

FIG. 6A shows codes implementing a widget function provided by one embodiment of the present invention.

FIG. 6B shows an example of description of a DOM structure provided by one embodiment of the present invention.

FIG. 7 shows a schematic layout of a system for checking test coverage according to one embodiment of the present invention.

### DETAILED DESCRIPTION

Some exemplary embodiments will be described in more detail with reference to the accompanying drawings, in which the exemplary embodiments of the present disclosure have been illustrated. However, the present disclosure can be implemented in various ways, and thus should not be construed to be limited to the embodiments disclosed herein. On the contrary, those embodiments are provided for the thorough and complete understanding of the present disclosure.

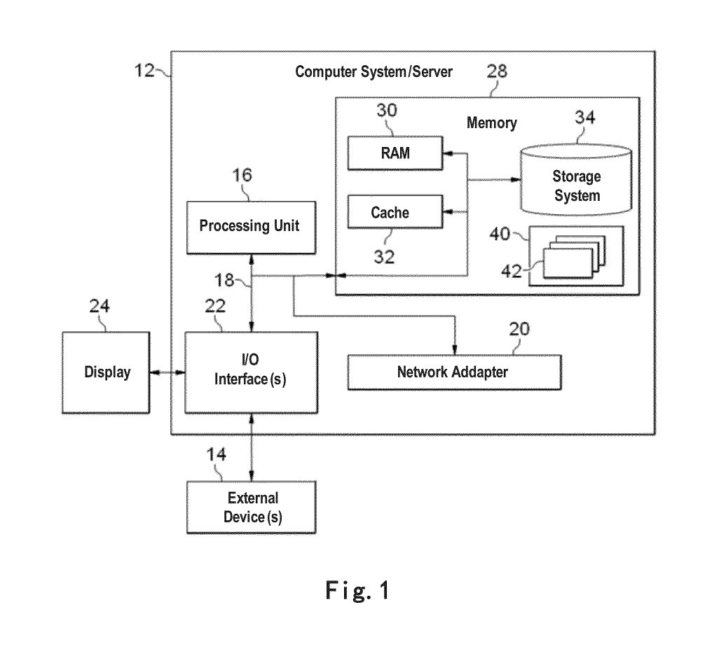

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The apparatus or system which is applicable to implement the embodiments of the present invention may further be a mobile terminal, such as a cellphone, a tablet PC, etc.

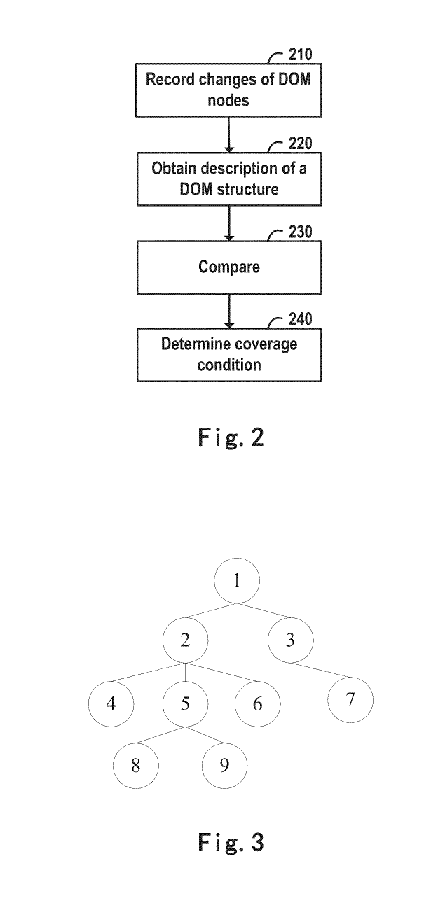

With reference now to FIG. 2, one embodiment of the present invention provides a method for checking testing coverage. The method comprises: in step 210, in response to testing a function of a widget, recording changes of Document Object Model (DOM) nodes of the widget; in step 220, obtaining description, such as program code, of a DOM structure corresponding to the function; in step 230, comparing the recorded changes of DOM nodes and the obtained description of the DOM structure; and in step 240, determining test coverage condition for the function. Using the method provided by this embodiment, testing coverage condition can be checked effectively no matter by manual testing or automated testing method. When testing a certain function, manually or automatically, changes of DOM nodes will be caused. Through a comparison with description of a DOM structure corresponding to the function, it may be judged whether the function is tested successfully.

In one embodiment of the present invention, step 210 may further comprise monitoring changes of DOM nodes by using the methods known in the art. Many browsers provide debugging tool plug-ins, which may be used to monitor changes of DOM nodes.

In one embodiment of the present invention, the changes of DOM nodes comprise, for example, at least one of changes of a hierarchical relationship between DOM nodes and changes of attributes of DOM nodes. Wherein a hierarchical relationship between DOM nodes may be represented using a DOM tree or in other form, e.g., a hierarchical relationship between DOM nodes may be recorded using an adjacency table and an adjacency matrix. For example, FIG. 3 shows a schematic view of a DOM tree that includes DOM nodes 1-9. It can be seen that when testing a function, a node 7 is deleted, which belongs to changes of a DOM tree structure. If originally there was no node 8, but with the function testing node 8 is added as a sub-node of a node 5, this also belongs to changes of the DOM tree structure. If a node 9 becomes a sub-node of a node 4 with the function testing, this also belongs to changes of the DOM tree structure. If node 4 becomes a sub-node of a node 6 with the function testing, this also belongs to changes of the DOM tree structure. DOM nodes have various attributes, such as color, position, dimension, foreground color, background color, display node, css class name, etc. If with the function testing, one or more attributes of DOM nodes change, then this belongs to changes of attributes of DOM nodes. For example, no matter if a tester or an automated program conducts a test, if the mouse hovers on a button, this button is highlighted, and then the background color of attributes of a corresponding DOM node will change and at the same time “dijitButtonComboHover” is added to the DOM node's css class name. That is, in response to testing a function, attributes of DOM nodes change.

In one embodiment of the present invention, in step 210 recording of changes DOM nodes may comprise, for example, at least one of: in response to changes of DOM nodes, recording all DOM nodes in a page where the widget is located; in response to changes of DOM nodes, recording DOM nodes which the function involves; in response to changes of DOM nodes, recording DOM nodes which the widget comprises. Where in response to changes of DOM nodes, all DOM nodes in a page where the widget is located are recorded, the corresponding amount of recording may be large, and when making a comparison in a subsequent step, the comparison may result in a large workload, but it is easy for implementation. Where in response to changes of DOM nodes, DOM nodes in which the functions involved are recorded, the amount of recording will reduce, and in a subsequent comparison, the workload of comparison may be small, wherein DOM nodes which the function involves may be determined according to the obtained description of DOM nodes of the function. Where in response to changes of DOM nodes, DOM nodes which the widget comprises are recorded, the amount of recording is less than all DOM nodes in a page where the widget is located but is more than DOM nodes which the function involves, and in a subsequent comparison, the workload of comparison is also immediate.

In one embodiment of the present invention, obtaining description of a DOM structure corresponding to the function in step 220 may be, for example, directly obtaining description of a DOM structure corresponding to the tested function from records provided by developers. After development, developers may provide, for example, a simple description of a DOM structure corresponding to each function, and description may be obtained in step 220. In another embodiment of the present invention, step 220 may directly extract a description of a DOM structure corresponding to the tested function from program code. The present invention is not intended to limit methods for obtaining descriptions of a DOM structure.

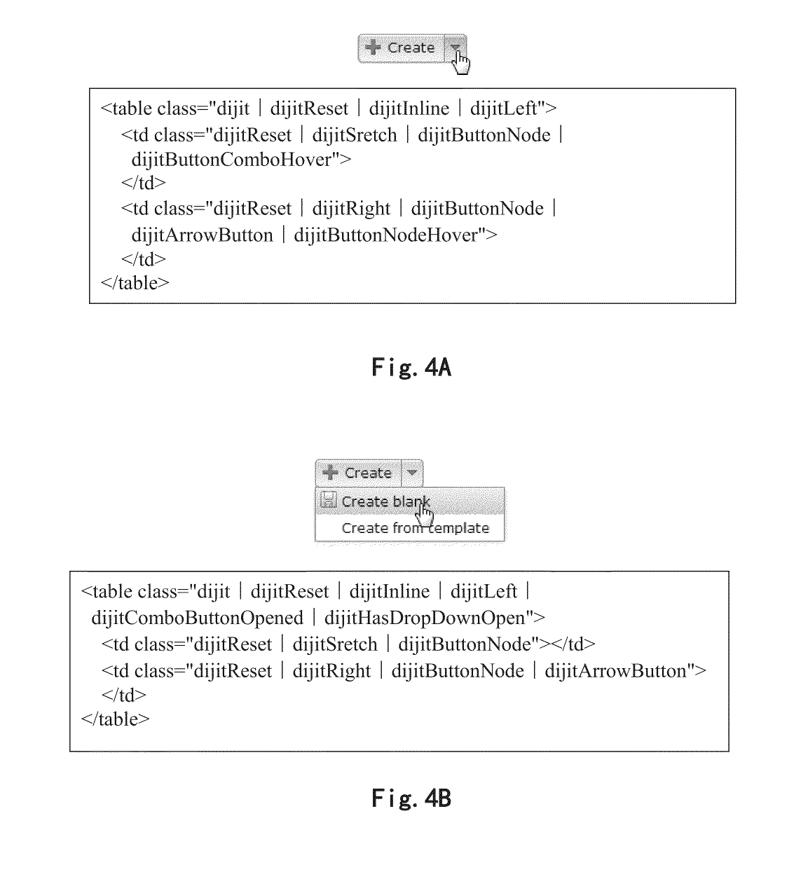

In one embodiment of the present invention, the obtained description of a DOM structure in step 220 may comprise, for example, a hierarchical relationship between DOM nodes corresponding to the tested function and attributes of DOM nodes. For example, as shown in FIGS. 4A and 4B, these figures provide a description of DOM structures corresponding to a function of highlighting when the mouse hovers and to a function of a dropdown menu popping up when the mouse clicks. With reference to FIG. 4A, the upper portion shows a diagram where the mouse hovers on a dropdown button, which indicates the function of highlighting when the mouse hovers on the dropdown button; the lower portion is description of a DOM structure corresponding to the highlight function. With reference to FIG. 4B, the upper portion is a diagram where a dropdown menu pops up, which indicates the dropdown menu pops up when the mouse clicks the dropdown button; the lower portion is description of a DOM structure corresponding to the function of dropdown menu popping up.

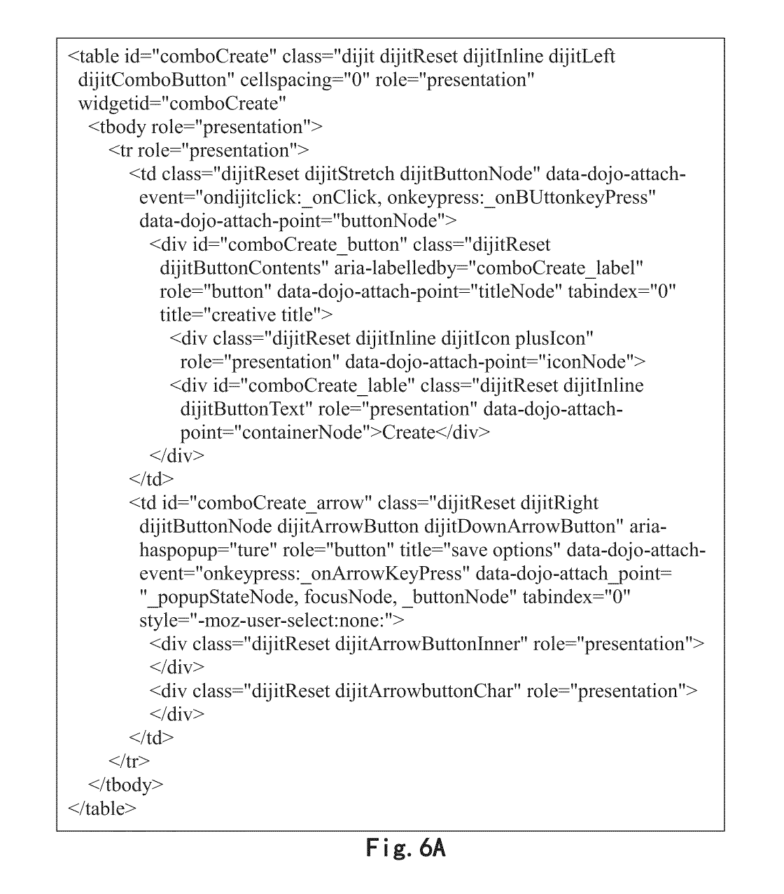

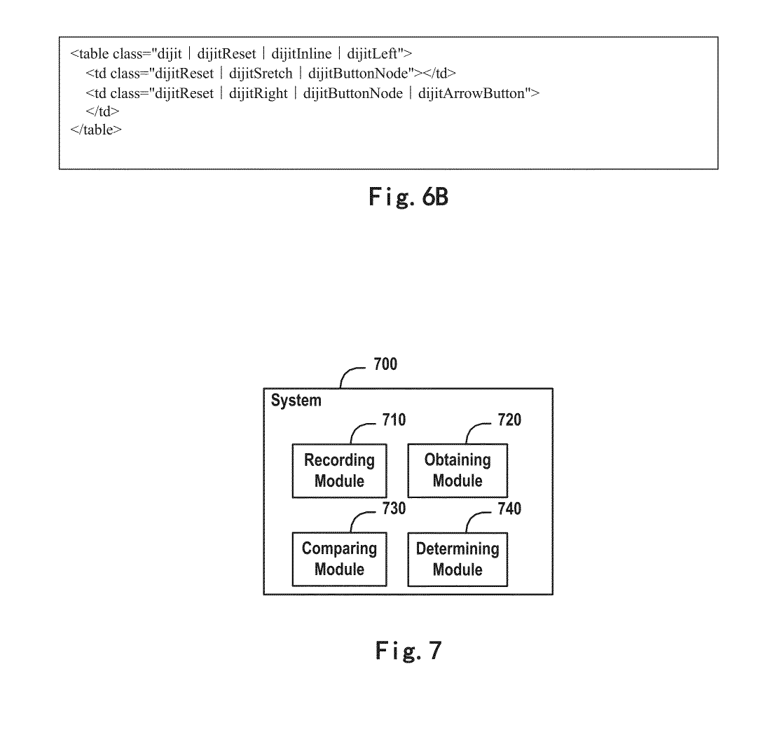

In one embodiment of the present invention, description of a DOM structure corresponding to the function comprises, for example, description of a root node and minimum sub-node corresponding to the tested function. The root node may be a root node of the widget, or a node at a certain hierarchy of the widget acting as a root node for the tested function. During implementation, for simplicity, the widget's root node may act as a root node of all functions, so that it is no longer necessary to differentiate between root nodes corresponding to respective functions. The minimum sub-node is a set of bottom sub-nodes for the tested function, but not necessarily bottom sub-nodes of the whole widget, and this set may comprise only one sub-node or multiple sub-nodes. With reference to program code provided in FIG. 6A, wherein the widget's root node is “table,” so “table” may act as a root node in description of the DOM structure. Corresponding to the function shown in FIGS. 4A and 4B, minimum sub-nodes corresponding to the function comprise a set consisting of 2 td nodes, so these 2 td nodes may be contained in description of the DOM structure as minimum sub-nodes. For example, regarding the initial status, description of a DOM structure may be obtained as shown in FIG. 6B. Corresponding to the function in FIG. 4A, by adding changing node attributes to a corresponding position in description of a DOM structure corresponding to final status, description of a DOM structure corresponding to the function shown in FIG. 4A is then obtained. The same principle applies to FIG. 4B, which is not detailed here. Using this embodiment, if description of a DOM structure only comprises description of corresponding root node and minimum sub-node of the tested function, then in a subsequent comparison, efficiency is high and the computation load is small.

In one embodiment of the present invention, step 230 for example comprises: judging whether in recorded DOM nodes there exists obtained description of a DOM structure. During concrete implementation, obtained description of a DOM structure may be searched for in recorded DOM nodes.

In one embodiment of the present invention, step 240 for example comprises: if the obtained description of a DOM structure does not exist in the recorded DOM nodes, determining the function is not covered by the test. Why the function is not covered by the test may be that the function fails to pass the testing or there lacks a test case for the function in the test.

In one embodiment of the present invention, step 240 for example comprises: calculating a ratio of the testing coverage. For example, the present test comprises 5 functions, wherein description of DOM structures of 3 functions is found among recorded DOM nodes while description of DOM structures of the remaining 2 functions is not found among recorded DOM nodes, so a ratio of the testing coverage is 60%.

In one embodiment of the present invention, the embodiment as shown in FIG. 2 for example further comprises the step of: outputting a report according to testing coverage condition. For example, the calculated ratio of the testing coverage is provided to the user in the form of a report. For another example, functions not covered are provided to the user in the form of a report. For a further example, a list of all functions and whether the function is covered by the test are provided to the user in a report. The report may be in a text form, a legend form, a table form or a combination thereof. The present invention is not intended to limit a form of the report, so long as the test coverage can be represented.

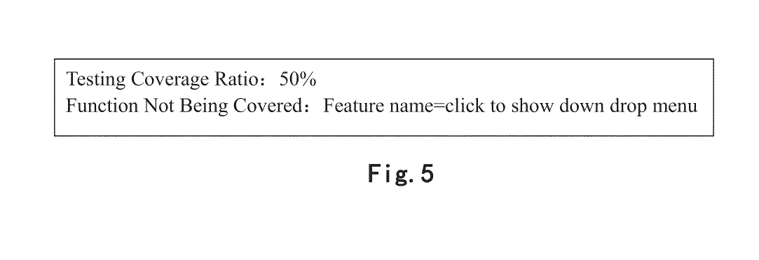

These embodiments may be combined and refer to each other for obtaining more embodiments. With references to FIGS. 4A, 4B and 5, examples of combining these embodiments are presented below, and those skilled in the art may obtain more with reference to these examples.

When the tester or automated testing program is testing the widget shown in FIG. 4A (embodied as a Create button with a dropdown arrow in FIG. 4A), in response to the mouse moving the dropdown arrow of the Create button, the dropdown arrow will be highlighted. Subsequently, in response to clicking the button, a dropdown menu as shown in FIG. 4B will pop up.

Changes of DOM nodes can be monitored by a browser plug-in, for example. When the mouse moves to the dropdown arrow, attributes of DOM nodes will change, i.e., highlighted. In response to monitoring such changes, DOM nodes in a page where the widget is located will be recorded. The present invention is not intended to limit a form of records, which may be a table, a file, etc. In response to finding description of a DOM structure as shown in the lower portion of FIG. 4A, it can be judged that the highlight function is tested successfully. When clicking the button as shown in FIG. 4A, a dropdown menu as shown in FIG. 4B will pop up; but during testing, the dropdown does not pop up. In response to not finding description of a DOM structure as shown in the lower portion of FIG. 4B, it may be judged that the “click to show down drop menu” function is not tested successfully. For example, the widget has only these two functions, and then a ratio of testing coverage is calculated as 50%, and a report as shown in FIG. 5 is provided to the user. It can be seen that the report includes the function not being covered and the ratio of test coverage. Wherein the function not being covered, for example, may directly provide feature name.

With reference to the accompanying drawings, description has been presented above to various embodiments implementing the method of the present invention. Those skilled in the art may understand the above method can be implemented in software, hardware or a combination of software and hardware. Moreover, those skilled in the art may understand by implementing various steps in the above methods in software, hardware or a combination of software and hardware, there may be provided a system for checking testing coverage. Even though these apparatus and system have the same hardware structure as a general-purpose processing device, the functionality of software contained therein makes these apparatus and system manifest distinguishing properties from the general-purpose processing device, thereby forming apparatus and system of the following embodiments of the present invention. With reference to FIG. 7, detailed description is presented below to a system for checking test coverage provided by one embodiment of the present invention.

As shown in FIG. 7, the embodiment of the present invention provides a system 700 for checking testing coverage. System 700 comprises: a recording module 710 configured to, in response to testing a function of a widget, record changes of DOM nodes of the widget; an obtaining module 720 configured to obtain description of a DOM structure corresponding to the function; a comparing module 730 configured to compare the recorded changes of DOM nodes and the obtained description of a DOM structure; a determining module 740 configured to determine test coverage condition for the function according to a comparison result. Using system 700 provided by this embodiment, testing coverage condition can be easily learned.

In one embodiment of the present invention, the changes of DOM nodes comprise at least one of changes of a hierarchical relationship between DOM nodes and changes of attributes of DOM nodes. For detailed description, reference may be made to the method embodiment, which is not detailed here.

In one embodiment of the present invention, recording module 710 for example comprises at least one of: a first recording sub-module configured to, in response to changes of DOM nodes, record all DOM nodes in a page where the widget is located; a second recording sub-module configured to, in response to changes of DOM nodes, record DOM nodes which the function involves; a third recording sub-module configured to, in response to changes of DOM nodes, record DOM nodes which the widget comprises. For advantages resulting from different sub-modules, reference may be made to the method embodiment, which is not detailed here.

In one embodiment of the present invention, the description of a DOM structure comprises: a hierarchical relationship between DOM nodes and attributes of DOM nodes. In another embodiment of the present invention, the description of a DOM structure corresponding to the function comprises: description of a root node and a minimum sub-node corresponding to the function.

In one embodiment of the present invention, comparing module 730 is specifically configured to judge whether in recorded DOM nodes there exists obtained description of a DOM structure.

In one embodiment of the present invention, determining module 740 is specifically configured to, if obtained description of a DOM structure does not exist in recorded DOM nodes, determine the function is not covered by the test.

For implementation details of these system embodiments, reference may be made to the corresponding method embodiments. These system embodiments may refer to and combine with each other for obtaining more embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for checking testing coverage, the method comprising:
in response to testing a function of a widget, recording changes of Document Object Model (DOM) nodes of the widget;
obtaining description of a DOM structure corresponding to the function;
comparing the recorded changes of DOM nodes and the obtained description of the DOM structure; and
determining testing coverage condition for the function according to a comparison result.

2. The method according to claim 1, wherein the changes of DOM nodes comprise at least one of changes: of a hierarchical relationship between DOM nodes; and changes of attributes of DOM nodes.

3. The method according to claim 1, wherein the recording changes of DOM nodes of the widget comprises at least one of:
in response to changes of DOM nodes, recording all DOM nodes in a page where the widget is located;
in response to changes of DOM nodes, recording DOM nodes which the function involves; and
in response to changes of DOM nodes, recording DOM nodes which the widget comprises.

4. The method according to claim 1, wherein the description of the DOM structure comprises a hierarchical relationship between DOM nodes and attributes of DOM nodes.

5. The method according to claim 1, wherein the description of the DOM structure corresponding to the function comprises description of a root node and a minimum sub-node corresponding to the function.

6. The method according to claim 1, wherein the comparing the recorded changes of DOM nodes and the obtained description of the DOM structure comprises judging whether in the recorded DOM nodes there exists the obtained description of the DOM structure.

7. The method according to claim 6, wherein the determining testing coverage condition for the function according to a comparison result comprises:
if the obtained description of the DOM structure does not exist in the recorded DOM nodes, determining the function is not covered by the test.

8. A computer system for checking testing coverage, the computer system comprising:
one or more computer processors, one or more computer-readable storage media, and program instructions stored on one or more of the computer-readable storage media for execution by at least one of the one or more processors, the program instructions comprising:
program instructions, in response to testing a function of a widget, to record changes of Document Object Model (DOM) nodes of the widget;
program instructions to obtain description of a DOM structure corresponding to the function;
program instructions to compare the recorded changes of DOM nodes and the obtained description of the DOM structure; and
program instructions to determine testing coverage condition for the function according to a comparison result.

9. The computer system according to claim 8, wherein the changes of DOM nodes comprise at least one of changes: of a hierarchical relationship between DOM nodes; and changes of attributes of DOM nodes.

10. The computer system according to claim 8, wherein the program instructions to record changes of DOM nodes of the widget comprises at least one of:
program instructions, in response to changes of DOM nodes, to record all DOM nodes in a page where the widget is located;
program instructions, in response to changes of DOM nodes, to record DOM nodes which the function involves; and
program instructions, in response to changes of DOM nodes, to record DOM nodes which the widget comprises.

11. The computer system according to claim 8, wherein the description of the DOM structure comprises a hierarchical relationship between DOM nodes and attributes of DOM nodes.

12. The computer system according to claim 8, wherein the description of the DOM structure corresponding to the function comprises description of a root node and a minimum sub-node corresponding to the function.

13. The computer system according to claim 8, wherein the program instructions to compare the recorded changes of DOM nodes and the obtained description of the DOM structure comprises program instructions to judge whether in the recorded DOM nodes there exists the obtained description of the DOM structure.

14. The computer system according to claim 13, wherein the program instructions to determine testing coverage condition for the function according to a comparison result comprises:
program instructions, if the obtained description of the DOM structure does not exist in the recorded DOM nodes, to determine the function is not covered by the test.

15. A computer program product for checking testing coverage, the computer program product comprising:
one or more computer-readable storage media and program instructions stored on the one or more computer-readable storage media, the program instructions comprising:
program instructions, in response to testing a function of a widget, to record changes of Document Object Model (DOM) nodes of the widget;
program instructions to obtain description of a DOM structure corresponding to the function;
program instructions to compare the recorded changes of DOM nodes and the obtained description of the DOM structure; and
program instructions to determine testing coverage condition for the function according to a comparison result.

16. The computer program product according to claim 15, wherein the changes of DOM nodes comprise at least one of changes: of a hierarchical relationship between DOM nodes; and changes of attributes of DOM nodes.

17. The computer program product according to claim 15, wherein the program instructions to record changes of DOM nodes of the widget comprises at least one of:
program instructions, in response to changes of DOM nodes, to record all DOM nodes in a page where the widget is located;
program instructions, in response to changes of DOM nodes, to record DOM nodes which the function involves; and
program instructions, in response to changes of DOM nodes, to record DOM nodes which the widget comprises.

18. The computer program product according to claim 15, wherein the description of the DOM structure comprises a hierarchical relationship between DOM nodes and attributes of DOM nodes.

19. The computer program product according to claim 15, wherein the description of the DOM structure corresponding to the function comprises description of a root node and a minimum sub-node corresponding to the function.

20. The computer program product according to claim 15, wherein the program instructions to compare the recorded changes of DOM nodes and the obtained description of the DOM structure comprises program instructions to judge whether in the recorded DOM nodes there exists the obtained description of the DOM structure.
